(19) United States
(12) Patent Application Publication
(10) Pub. No.: US 2025/0013938 A1
(43) Pub. Date: Jan. 9, 2025

(54) SYSTEM AND METHOD FOR A WATER STRESS INDEX

(71) Applicant: True Elements, Inc., Naples, FL (US)

(72) Inventors: William C. LOUISELL, III, Mt. Pleasant, SC (US); David BANKSTON, Naples, FL (US)

(21) Appl. No.: 18/763,298

(22) Filed: Jul. 3, 2024

Related U.S. Application Data
(60) Provisional application No. 63/525,098, filed on Jul. 5, 2023.

(51) Int. Cl. G06Q 10/04; G06F 16/29; G06F 30/27; G06F 113/08; G06Q 50/26

(52) U.S. Cl. CPC G06Q 10/04; G06F 16/29; G06F 30/27; G06Q 50/26; G06F 2113/08

(57) ABSTRACT

Systems, methods, and computer-readable storage media for a water stress index, and more specifically to using artificial intelligence to predict the stress of a watershed due to water or lack thereof. A system can receive data such as hydrological, soil, and weather data associated with a geographic region, and based on that data generate a likely rainfall event series for the geographic region. The system can then build, using the likely rainfall event series, a storm pattern model, and generate a water scarcity value for the geographic region based on the data and the storm pattern model. The system can receive (e.g., from a user) a desired assessment period and a recurrence interval, then execute the storm pattern model using the assessment period, the recurrence interval, and the water scarcity value, resulting in at least one predicted weather effect for the geographic region.

### CROSS-REFERENCE

This application claims priority to U.S. Provisional Patent Application No. 63/525,098, filed Jul. 5, 2023, the contents of which are incorporated herein in their entirety.

### BACKGROUND

### 1. Technical Field

The present disclosure relates to a water stress index, and more specifically to using artificial intelligence to predict the stress of a watershed due to water or lack thereof.

### 2. Introduction

Many people are feeling the effects of climate change in a way that will alter the way their watershed is performing compared to previous times, and that watershed may continue to become altered over time. While some watersheds will become wetter, other watersheds will become dryer. Still other watersheds may flip from wet to dry and back multiple times before settling on a “new normal.”

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media which provide a technical solution to the technical problem described. A method for performing the concepts disclosed herein can include: receiving, at a computer system, a plurality of data, the data comprising at least one of hydrological, soil, and weather data associated with a geographic region; generating, via at least one processor of the computer system based on the plurality of data, at least one likely rainfall event series for the geographic region; building, via the at least one processor using the at least one likely rainfall event series, a storm pattern model; generating, via the at least one processor, a water scarcity value for the geographic region based on the data and the storm pattern model; receiving, at the computer system, an assessment period and a recurrence interval; and executing the storm pattern model via the at least one processor using the assessment period, the recurrence interval, and the water scarcity value, resulting in at least one predicted weather effect for the geographic region.

A system configured to perform the concepts disclosed herein can include: at least one processor; and a non-transitory computer-readable storage medium having instructions stored which, when executed by the at least one processor, cause the at least one processor to perform operations comprising: receiving a plurality of data, the data comprising at least one of hydrological, soil, and weather data associated with a geographic region; generating, based on the plurality of data, at least one likely rainfall event series for the geographic region; building a storm pattern model using the at least one likely rainfall event series; generating a water scarcity value for the geographic region based on the data and the storm pattern model; receiving an assessment period and a recurrence interval; and executing the storm pattern model using the assessment period, the recurrence interval, and the water scarcity value, resulting in at least one predicted weather effect for the geographic region.

A non-transitory computer-readable storage medium configured as disclosed herein can have instructions stored which, when executed by at least one processor, cause the at least one processor to perform operations which include: receiving a plurality of data, the data comprising at least one of hydrological, soil, and weather data associated with a geographic region; generating, based on the plurality of data, at least one likely rainfall event series for the geographic region; building a storm pattern model using the at least one likely rainfall event series; generating a water scarcity value for the geographic region based on the data and the storm pattern model; receiving an assessment period and a recurrence interval; and executing the storm pattern model using the assessment period, the recurrence interval, and the water scarcity value, resulting in at least one predicted weather effect for the geographic region.

### BRIEF DESCRIPTION OF THE DRAWINGS

FIG. 1 illustrates an example AI engine generating a current level of water stress based on real-time sensor data and historical data;

FIG. 2 illustrates an example of modeling riverine conditions for a geographic area;

FIG. 3 illustrates an example method embodiment; and

FIG. 4 illustrates an example computer system.

### DETAILED DESCRIPTION

Various embodiments of the disclosure are described in detail below. While specific implementations are described, this is done for illustration purposes only. Other components and configurations may be used without parting from the spirit and scope of the disclosure.

The proposed water stress index represents a break from traditional methods of reporting water stress which are limited to exploring the past and the current timeframe. While this information can be useful in static or slowly changing environments, it falls short of providing insight into the near-, mid-, and long-term outlook which leaves a shortfall in stakeholder understanding of the impact of climate change.

The system disclosed herein changes that status quo by combining the data traditionally associated with water stress reporting with an Artificial Intelligence (AI) powered climate forecasting module that resolves rainfall and temperature patterns in the U.S. down to a 5 km by 5 km grid square (or other geographic region) for any of the named United Nations (UN) Intergovernmental Panel on Climate Change (IPCC) climate forecasts. The various embodied AI methods can quantify the impacts changing precipitation and temperature patterns will have on groundwater availability; groundwater recharge potential; stream flow loadings, riverine flooding; and coastal flooding associated with the interaction between riverine flows, stormwater runoff, and rising sea level for any location in the U.S. (or other countries) at any time frame.

Forecasts of this nature are extremely valuable to industry and public service professionals (e.g., policymakers, administrators, planners, engineers, and the general public) as they assess future risks and make decisions on climate change migration and resiliency strategies. The system is unique in its ability provide hydrology and hydraulics professionals with the ready-to-use forecast data they need to assess the potential consequences associated with the ever evolving ‘new normal’ associated with climate change in terms of precipitation and temperature profiles.

Quantifying the state of a watershed in terms of stress is a technical problem relying on specific data from multiple sources/location, and requiring advanced solutions including the use of Artificial Intelligence (AI) and hierarchical modeling. As an example—forms of stress in streams and rivers are related to flow volume and velocity that can be the result of excess rainfall events. In fact, a specific example relates to a recent event near Yellowstone National Park (2023). Experts believe that the Montana railcar incident was likely caused by “bridge scour,” where fast-moving water erodes bridge foundations. According to experts, an estimated 60% of bridge failures result from scour. Scour occurs when sediment, like sand and gravel, is washed away from around bridge abutments or piers, compromising the structure's stability.

High water levels and flow intensity due to rapid snow melt and increased storm intensity in the Yellowstone area over the past few years likely increased the severity of bridge scour generating the conditions for failure. For elected officials and the traveling public this event is alarming, but this may be an indicator of things to come as we increasingly realize the effects of changing climate.

Reinforcing the need for a system such as the one disclosed herein is recent research which indicates that, for many areas in the United States, climate change will be realized in the form of water risk that is generated by the changing volumes and patterns of rainfall. An increased frequency of high intensity storms in terms of inches per hour and concentrated in highly responsive runoff areas will lead to an increased frequency of extreme runoff events that serve as the damage mechanism across many use cases including, but not limited, to stream bank erosion, bridge scour, and flooding.

The fact that affected assets are owned and operated by a wide range of state and local government entities, as well as private industries, compounds the problem of ensuring that the right officials understand how vulnerability to use cases such as those previously mentioned is distributed in terms of stream reaches (i.e., a length of a stream or river; often a small section of a stream or river rather than its entire length), coastlines, and specific locations. It also affects how actions in one jurisdiction or location may have downstream consequences that affect other jurisdictions or locations.

Systems configured as disclosed herein can help answer questions at scale, such as “what changes in bridge scour potential will I likely see in my district in 5-, 10-, 25-years or more in the future?” and “which assets are most at risk earliest?” Systems configured as disclosed herein can provide a map-based risk display that allows stakeholders to see problem areas and test a wide range of climate change scenarios to see the impact on the primary bridge scour damage mechanisms.

The bridge mentioned in the earlier problem is only one of many use cases. A representative portfolio includes but is not limited the propensity, frequency, and seasonality of the following: rapid snow-melt events, groundwater recharge potential, stream bank erosion, bridge scour, dam loadings, riverine flooding, and non-storm surge related coastal flooding.

The system disclosed herein is underpinned by climate change data generated by the International Panel on Climate Change (IPCC), reported by the National Oceanic and Atmosphere Administration (NOAA) in the U.S. Climate Resiliency Toolkit (a website provided by the U.S. government which provides guidance, tools, and resources for planners and the general public to help understand impacts of climate change for their communities). The Resiliency Toolkit is an informative source of relatively high-level information, but it lacks the detail required to do specific planning and design for climate resiliency investment. The system disclosed herein responds to this need. It transforms this high-level information into high resolution location and timeframe specific data using a unique set of AI algorithms, resulting in a precipitation forecast in the form of conventional planning and design data (i.e., representative daily and hourly forecasts) for a future period at any user specified time of interest (the current limit of IPCC climate change data is the year 2100, but the system is configured to operate beyond such limits when data is available).

To create this precipitation forecast, the system first translates the high-level data provided in the Climate Resiliency Toolkit into a likely rainfall event series. The event series is tailored by the system via an AI algorithm to generate hourly forecasts using a subroutine that derives actual (i.e., “vice theoretical”) rainfall patterns, with those rainfall patterns reflecting probabilities of storms of various intensity. Beyond intensity, the system can determine the change vectors of the rainfall forecasts, such as volume and frequency over time and quantify the rate of change for each such vector such that forward looking time-series forecasts can be generated.

Next, the AI algorithm (or an additional AI algorithm) builds recommended storm patterns for evaluation, such that the user is able to conduct assessments across the aforementioned use cases (e.g., groundwater availability assessments, surface water flow rate and velocity assessments, and/or flooding assessments) for any user specified storm series durations, including the duration recommended by the system based on historical data. In addition, the user can use customary assessment periods corresponding to lengths of storms/events (e.g., 24-, 48-, 72-, and/or 96-hour events) at any standard recurrence interval (e.g., 2-, 5-, 10-, 25-, 50-, 100-, 500-, and/or 1000 years).

With the assessments available, the system can receive data (such as, but not limited to, a hydrography model of a geographic region, historical amounts of rainfall, soil properties, etc.) and generate one or more index values that indicate change from the current NWS-defined 30-year comparison epochs. An index is generated for each of the three major areas of concern (groundwater availability, surface water flows, and coastal flooding) as an indicator of concern. An index value, as used herein, is used to identify how a current assessment compares against a longer time domain (e.g., “where does a current climate assessment rank when compared to the environment of that geographic area over the past century (or other time frame)?”). The index value is an entry to further assessment supported by sub-indices. Non-limiting examples of sub-indices generated by the system can include: a sea level rise index, a seasonal tide index, a runoff index, a precipitation index, a drought index of change, and/or a seasonal precipitation index. These index values generated by the system can indicate if there is an excess of water or a scarcity of water, preferably indicated on a positive/negative (otherwise indicated as +/−) scale, such as +100 indicating a water surplus, −100 indicating a water scarcity, and 0 indicating a water balance. Other scales (e.g., +10 to −10) can likewise be used. The index values can then be used, in combination or alone, to predict specific conditions. For example, the sea level rise index and the seasonal tide index can be used to generate a prediction of coastal conditions. Likewise, the runoff index and the precipitation index can be used to generate a prediction of riverine conditions, and the drought index of change can be used with the seasonal precipitation index to predict drought conditions. In other configurations, additional indices and corresponding conditions developed from those conditions can be generated using the same data or additional data. Preferably, these predictions are made using AI algorithms, where the AI is trained using past data and known conditions.

The specific AI developed for this system first builds individual rainfall event influencing variable forecasts: historical temporal observation of trends, historical spatial patterns of realization (i.e. microclimates, the base values of precipitation data (IPCC), base values of variation (historical)), and the influences of major meteorological cycles (El Niño/La Niña). These forecasts are developed using multiple historical data sets that reflect historical patterns observed over extended periods of time (e.g., up to 20, 50, or 100 years). This historical data can include, but is not limited to: microclimate effects on localized rainfall realization for a given geographic area (e.g., an identified city with known boundaries, a 1 km circle, a 5 km by 5 km grid, etc.); localized influence associated with specific year-to-year and/or epoch-to-epoch influencing earth cycles (e.g., El Niño/La Niña); and the rate of change of the climate patterns associated with each of the various IPCC approved global warming level forecasts.

With the individual influencing variable trajectories of these forecasts developed, the AI manages how the influence vectors of the forecasts associated with each applicable phenomena influence the AI output and, in some cases, how they influence each other i.e. the influence of El Nino/La Nina on the spatial pattern of distribution and/or the base values of precipitation using a neural network. In the initial edition of the neural network, connections between variables and intermediate aggregation layers are set based on the best available science. This initial edition is then trained using historical data. For example, localities that reflect the characteristics associated with a particular EPA rain region may yield a portfolio of initially trained networks. These trained networks can then be deployed to and continuously trained with respect to the relationships between precipitation, land cover, runoff volumes, and riverine flow metrics (volume, velocity, and stage) using, for example: sensor data where available, and the National Weather Service daily rainfall reports and National Water Model daily riverine loading reports when no sensor data is applicable.

Once the system has calculated individual conditions (e.g., costal conditions, riverine conditions, drought conditions), it can generate an overall water balance score (this is the same as the water scarcity score/value discussed above) for the geographic area. This water balance score can be generated using an AI algorithm, which can be a separate AI algorithm from those used before, or can be an alternate output of a common AI algorithm. The water balance can again be on a positive/negative (+/−) scale, and can be used by yet another AI algorithm to identify predicted effects, changes, or outcomes of the water balance.

Consider the following example. In a given area, there may be a long-term drought with a severe storm, resulting in a long-term water scarcity (i.e., in the floodplain) with a short-term water excess (i.e., in the riverine system), while both the floodplain and the riverine system are in the same watershed/geographic area. When such contradictions exist, the system can identify that while the overall system is, at present, close to neutral due to the storm, the long-term effects of the drought will take longer to correct than the water provided by a short-term flood.

For each geographic area (i.e., watershed), the system can generate a model based on the geographic, riverine, and/or other characteristics of that geographic area. Through this process the regional neural networks are trained to support forecasts at the stream reach level as defined by the National Hydrographic Dataset. In addition, an experience record for tracking the differences (i.e., the “missed distance”) between the forecasts and the calibration United States Geological Survey (USGS) sensor or National Water Model (NWM) is built, allowing the AI method to conform to changing patterns such that those patterns can be projected/forwarded into the future year of interest given the measured differences between the historical precipitation pattern and the system generated future pattern.

This can be accomplished, for example, using a combination of soil data, hydrological data, elevation/contour data, city/rural/agricultural information, et., such that the system can generate a model not only for every single watershed, but for the different potential microclimates within the watershed. For example, consider a watershed where some of the terrain is elevated with a forest in the elevated terrain, while at the lower elevation is an arid tree-free region. This common watershed may be sub-divided into an alpine region (the elevated/forested region) and an arid region (the lower tree-free region). In such an example, weather than effects one region may not affect the other (e.g., rain in the arid region), while weather in the alpine region does affect the arid region (e.g., rain moves downstream from the alpine region into the arid region). Such models can be built for any geographic area, watershed, or other region. In some configurations, the models are made for 5×5 kilometer areas (or other geometric shapes/sizes), whereas in other configurations the models follow specific watershed or hydrological areas.

Next, consider coastal conditions. NOAA produces reports indicating that in Charleston, South Carolina, the 2010 sea level was “X”. By 2023 there may be a change “Y”, such that the sea level is now at “X+Y”, with that gradient (Y/13 years) can then be used to forecast what the sea level will be in the future. The system described herein is different from the NOAA reports identifying that the sea level is rising or how much it rose and may rise under varying climate change conditions associated with global temperature changes. Instead, the system identifies the underlying coastal conditions such as the potential for interactions between sea conditions and fresh water riverine and runoff conditions.

Because tides and stormwater runoff often interact, the disclosed system becomes more important. As an example, often a coastal community can withstand a particular excess tidal condition or, independently, withstand the surface water impact of a particular local, and/or a regional precipitation event, but in the case where the two events are near-concurrent or concurrent, the community is likely to suffer significant property damage and potential loss of life.

To support this capability, the system and uses underlying coastal conditions together with the sea level and change information provided by NOAA, to predict how the sea level will affect a specific community or coastal area under a range of conditions. One such condition is the case in which there is a high tide situation driven by solar-lunar interactions that vary through the course of a particular year, and which vary year-by-year through the course of sequential 17.5 year lunar influence cycles.

To support stakeholders in need of this information to guide climate resiliency efforts, the system considers the terrain elevation. In addition, it considers the various astronomical elements that influence tide levels, and the previously described unique capability to forecast: (a) the potential for precipitation-driven runoff, (b) the resulting riverine flows, and (c) the resulting surface runoff sheet flows due to climate change. A specific case in point is the experience in Charleston, South Carolina in December of 2023, when particularly high tides cycles occurred simultaneously with peak run off flows generated by a non-tropical excessive rainfall event, leading to flooding levels second only by inches to the flooding experienced during Hurricane Hugo (Category 5) in October of 1989.

The unique capability to identify potential interactions between disparate types of conditions is, in this example, generated by aligning known cyclical tidal behaviors with the AI that provides the location and time specific future precipitation forecasts. This alignment enables identification of threatening tidal and meteorological phenomena intersections. The system can, for a specific coastal location at a specific future point in time, provide quantitative insight into the vulnerability to coastal flooding under a range of climate change conditions, where those conditions indicate the level of storm required to trigger such an event, the period of time (days in a year) that the community will be vulnerable to such an event, and how those measures may change under an evolving climate change trajectory.

In some configurations, the AI algorithm(s)/engine(s) used to make the predictions can be coupled with fuzzy inference and/or a neural network, and, if necessary, can flag the conditions for human review.

The system can generate separate models for each region based on soil data, historical water levels, amount of rain, water quality, and/or other factors for each geographic/hydrological region. For each reach with in the subject geographic/hydrologic area, the system can provide a precipitation forecast responsive indication of short-term stream bank erosion, compare that anticipated stream bank erosion against other streams, and identify each stream by an identification number, allowing the system to quickly provide a user with predicted effects of the water balance under different weather forecasts. This same capacity can be used by the system to provide meaningful forecasts on the impacts of weather for a given environment. For example, in a city or other area with non-permeable surface areas (e.g., streets, buildings), the runoff from a small amount of water can cause a large problem compared to a more rural area where the water can be more readily absorbed.

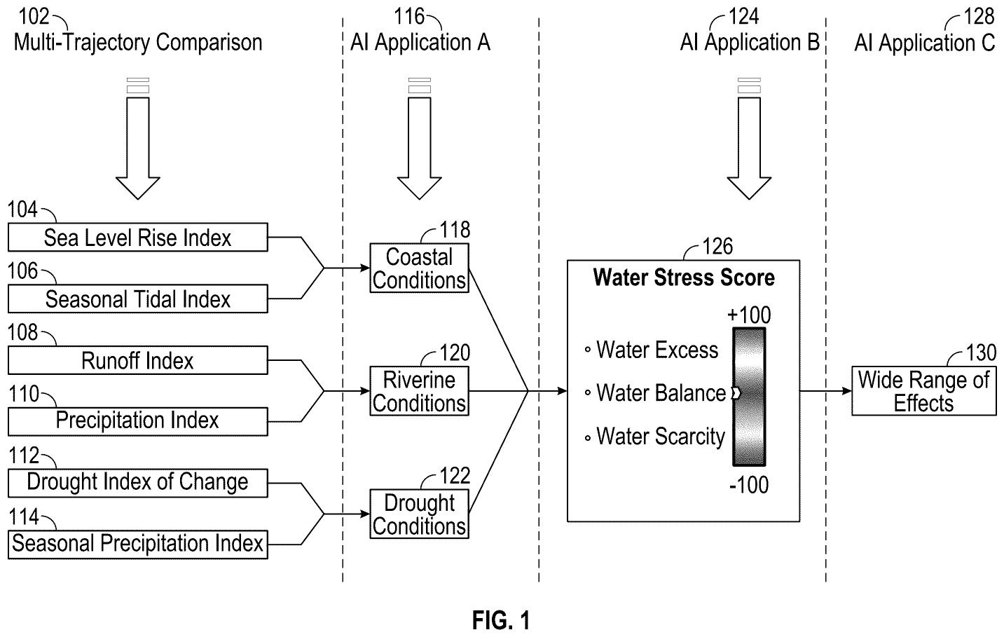

FIG. 1 illustrates an example AI engine generating a current level of water stress based on real-time sensor data and historical data. In this example, the system uses a multi-trajectory comparison 102 of sensor data to generate indices (such as, but not limited to a Seal Level Rise Index 104, a Seasonal Tidal Index 106, a Runoff Index 108, a Precipitation Index 110, a Drought Index of Change 112, and a Seasonal Precipitation Index 114), then uses those indices to identify (using an AI Application A 116) general conditions 118, 120, 122 related to various locations or features. In this example, the conditions (and associated indices) are Coastal conditions 118, Riverine conditions 120, and Drought conditions 122, though in other configurations there may be more or fewer such conditions. The system, using another AI Application B 124, can then generate a water stress score 126 (also called a water balance score) based on the conditions 118, 120, 122. The water stress score 126 provides a value indicating if there is an excess of water, a scarcity of water, or a balance of water within a geographic area or region. In some configurations, water stress score 126 can also be based on the sensor data and/or generated indexes 104, 106, 108, 110, 112, 114. Yet another AI Application C 128 can use the water stress score 126 (and/or the conditions 118, 120, 122, the indexes 104, 106, 108, 110, 112, 114, and/or the original sensor data) to predict a wide range of effects which may occur within the geographic area due to weather. This prediction can be based on a window of time (e.g., 10 years, or 100 years) as well as assumptions regarding frequency of certain weather effects, as described elsewhere herein. The AI Applications A 116, B 124, and C 128 can be a single AI Application which performs all of these features, or can be two, three, or more AI Applications which performs some aspects of these features. For example, there may be distinct AI Applications for identifying coastal conditions 118, riverine conditions 120, drought conditions 122, and/or other conditions. Likewise, there may be distinct AI Applications for each different condition, with the system generating different indices as needed for the different conditions. In addition, the AI applications 116, 124, 128 may include building one or more models which simulate, based on historical data, weather effects within the geographic region, such that executing of the model can provide predictions 130 about how the weather will affect certain aspects of the geographic region. Such predictions 130 (or predicted effects) may include bridge scour, erosion, likelihood of mudslides, availability of water, quality of water, likelihood of flooding, etc. Such predictions 130 may be predicted for specific locations within the geographic region (i.e., how will a specific bridge be affected by yearly flash floods?).

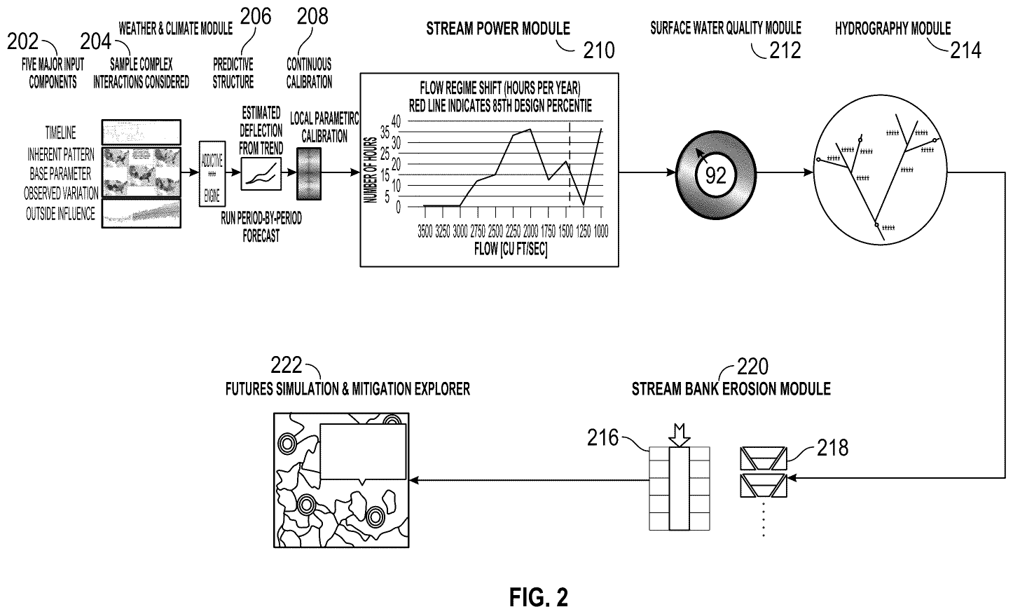

FIG. 2 illustrates an example of modeling riverine conditions, specifically, the potential for streambank erosion, for a particular geographic area. In this example, the system uses the sensor data and puts it through a series of modules, or processes, to simulate the future effects a user-defined climate change scenario will have on precipitation and stormwater. This process is sequential, with each sub-process executed one after the other. In this example, the system executes a weather and climate module (which can determine the expected water balance for the user-specified year of interest for the region) and, in this case, the water balance component of interest would be the level of runoff.

Continuing in FIG. 2, within the weather and climate module are aspects such as the five major input components 202 illustrated (there can be more, as needed): (1) a timeline related trendline for future precipitation; (2) an inherent spatial distribution pattern of variation in rainfall for the region pattern (i.e., micro-climates); (3) a base parameter of the expected precipitation levels (IPCC Data derived); (4) an observed variation (historical data derived); and (5) an outside influence (in the US-El Niño/La Niña). Using those inputs, the weather and climate module can sample complex interactions 204 (e.g., via execution of an AI model) between the five major input components 202, resulting in a predictive structure 206 for the geographic region, with estimated deflections from the trend that reflect the influence of the other four input components, and can execute periodic-specific forecasts. This allows the weather and climate module to reflect the locally (e.g., a 5 km×5 km grid or other geographic area), continuously calibrated 208 precipitation forecasts for the user-specified year or period of interest.

Continuing in FIG. 2, the weather and climate module is followed by a stream power module 210 (which can determine if the flow impact of stormwater runoff is potentially outside of previously identified “safe” ranges). The system can then evaluate the surface water via a surface water quality module 212, together with a hydrography module 214, to determine where and how water will be flowing, and using any of the previously calculated information can predict stream bank erosion using a stream bank erosion module 220 which reflects key parametric inputs such as channel geometry, soil types, and vegetation.

Continuing in FIG. 2, for a given stream 216 within different geographic sub-regions of the watershed of interest, the stream bank erosion module can predict how much erosion will occur at each segment 218. The system can then execute a futures simulation and mitigation explorer 222, which runs excursions to test and report to the user the benefits of particular proposals, such as but no limited to nature-based solutions including infiltration basins, bio-retention areas, natural stormwater conveyance channels, reforestation, and/or stream path meander cells.

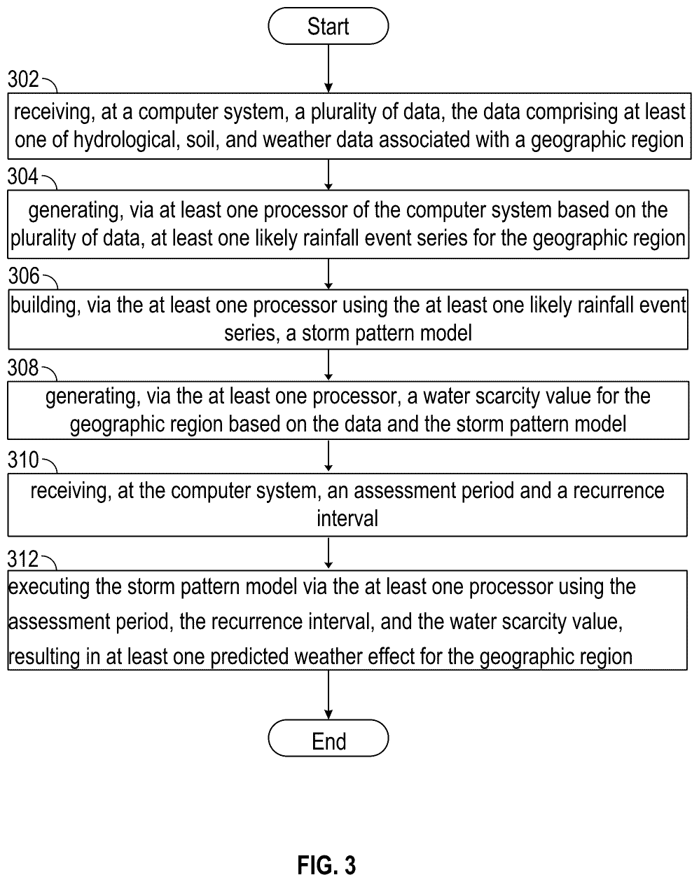

FIG. 3 illustrates an example method embodiment. As illustrated, a method for performing the concepts disclosed herein can include: receiving, at a computer system, a plurality of data, the data comprising at least one of hydrological, soil, and weather data associated with a geographic region (302), and generating, via at least one processor of the computer system based on the plurality of data, at least one likely rainfall event series for the geographic region (304). The method continues by building, via the at least one processor using the at least one likely rainfall event series, a storm pattern model (306) and generating, via the at least one processor, a water scarcity value for the geographic region based on the data and the storm pattern model (308). The method then includes receiving, at the computer system, an assessment period and a recurrence interval (310) and executing the storm pattern model via the at least one processor using the assessment period, the recurrence interval, and the water scarcity value, resulting in at least one predicted weather effect for the geographic region (312).

In some configurations, the illustrated method can further include generating, via the at least one processor based on the plurality of data, at least one predicted condition of the geographic region, the at least one predicted condition comprising at least one of: a coastal condition; a riverine condition; or a drought condition.

In some configurations, the at least one predicted weather effect can include bridge scour.

In some configurations, the water scarcity value can indicate if there is a water excess, a water scarcity, or a water balance in the geographic region.

In some configurations, the storm pattern model and the least one likely rainfall event series are distinct Artificial Intelligence (AI) models. In other configurations, they can be part of a singular AI model. Such models can, for example, be trained neural networks.

In some configurations, the illustrated method can further include: receiving, at the computer system, a hydrological model of the geographic region, wherein the building of the storm pattern model is further based at least in part on the hydrological model.

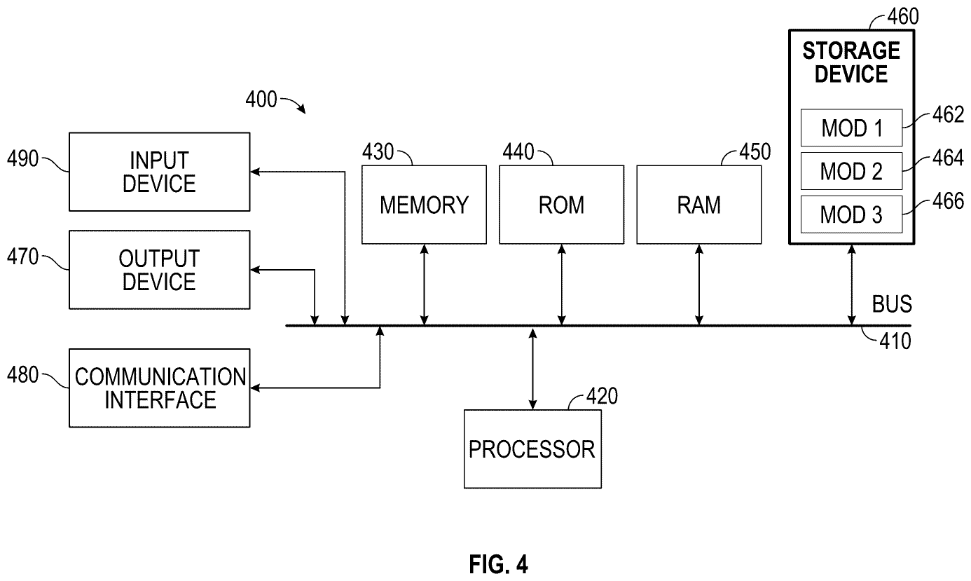

FIG. 4 illustrates an example computer system. With reference to FIG. 4, an exemplary system includes a computing device 400 (such as a general-purpose computing device), including a processing unit (CPU or processor) 420 and a system bus 410 that couples various system components including the system memory 430 such as read-only memory (ROM) 440 and random access memory (RAM) 450 to the processor 420. The computing device 400 can include a cache of high-speed memory connected directly with, in close proximity to, or integrated as part of the processor 420. The computing device 400 copies data from the system memory 430 and/or the storage device 460 to the cache for quick access by the processor 420. In this way, the cache provides a performance boost that avoids processor 420 delays while waiting for data. These and other modules can control or be configured to control the processor 420 to perform various actions. Other system memory 430 may be available for use as well. The system memory 430 can include multiple different types of memory with different performance characteristics. It can be appreciated that the disclosure may operate on a computing device 400 with more than one processor 420 or on a group or cluster of computing devices networked together to provide greater processing capability. The processor 420 can include any general-purpose processor and a hardware module or software module, such as module 1 462, module 2 464, and module 3 466 stored in storage device 460, configured to control the processor 420 as well as a special-purpose processor where software instructions are incorporated into the actual processor design. The processor 420 may essentially be a completely self-contained computing system, containing multiple cores or processors, a bus, memory controller, cache, etc. A multi-core processor may be symmetric or asymmetric.

The system bus 410 may be any of several types of bus structures including a memory bus or memory controller, a peripheral bus, and a local bus using any of a variety of bus architectures. A basic input/output (BIOS) stored in memory ROM 440 or the like, may provide the basic routine that helps to transfer information between elements within the computing device 400, such as during start-up. The computing device 400 further includes storage devices 460 such as a hard disk drive, a magnetic disk drive, an optical disk drive, tape drive or the like. The storage device 460 can include software modules 462, 464, 466 for controlling the processor 420. Other hardware or software modules are contemplated. The storage device 460 is connected to the system bus 410 by a drive interface. The drives and the associated computer-readable storage media provide nonvolatile storage of computer-readable instructions, data structures, program modules and other data for the computing device 400. In one aspect, a hardware module that performs a particular function includes the software component stored in a tangible computer-readable storage medium in connection with the necessary hardware components, such as the processor 420, system bus 410, output device 470 (such as a display or speaker), and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the computing device 400 is a small, handheld computing device, a desktop computer, or a computer server.

Although the exemplary embodiment described herein employs the storage device 460 (such as a hard disk), other types of computer-readable media which can store data that are accessible by a computer, such as magnetic cassettes, flash memory cards, digital versatile disks, cartridges, random access memories (RAMs) 450, and read-only memory (ROM) 440, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 400, an input device 490 represents any number of input mechanisms, such as a microphone for speech, a touch-sensitive screen for gesture or graphical input, keyboard, mouse, motion input, speech and so forth. An output device 470 can also be one or more of a number of output mechanisms known to those of skill in the art. In some instances, multimodal systems enable a user to provide multiple types of input to communicate with the computing device 400. The communications interface 480 generally governs and manages the user input and system output. There is no restriction on operating on any particular hardware arrangement and therefore the basic features here may easily be substituted for improved hardware or firmware arrangements as they are developed.

The technology discussed herein refers to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. For example, unless otherwise explicitly indicated, the steps of a process or method may be performed in an order other than the example embodiments discussed above. Likewise, unless otherwise indicated, various components may be omitted, substituted, or arranged in a configuration other than the example embodiments discussed above.

Further aspects of the present disclosure are provided by the subject matter of the following clauses.

A method comprising: receiving a plurality of data, the data comprising at least one of hydrological, soil, and weather data associated with a geographic region; and generating a water balance score, the water balance score indicating a level of water-related stress upon the geographic region.

A method comprising: receiving, at a computer system, a plurality of data, the data comprising at least one of hydrological, soil, and weather data associated with a geographic region; generating, via at least one processor of the computer system based on the plurality of data, at least one likely rainfall event series for the geographic region; building, via the at least one processor using the at least one likely rainfall event series, a storm pattern model; generating, via the at least one processor, a water scarcity value for the geographic region based on the data and the storm pattern model; receiving, at the computer system, an assessment period and a recurrence interval; and executing the storm pattern model via the at least one processor using the assessment period, the recurrence interval, and the water scarcity value, resulting in at least one predicted weather effect for the geographic region.

The method of any preceding clause, further comprising: generating, via the at least one processor based on the plurality of data, at least one predicted condition of the geographic region, the at least one predicted condition comprising at least one of: a coastal condition; a riverine condition; or a drought condition.

The method of any preceding clause, wherein the at least one predicted weather effect comprises bridge scour.

The method of any preceding clause, wherein the water scarcity value indicates if there is a water excess, a water scarcity, or a water balance in the geographic region.

The method of any preceding clause, wherein the storm pattern model and the least one likely rainfall event series are distinct Artificial Intelligence models.

The method of any preceding clause, wherein the distinct Artificial Intelligence models are trained neural networks.

The method of any preceding clause, further comprising: receiving, at the computer system, a hydrological model of the geographic region, wherein the building of the storm pattern model is further based at least in part on the hydrological model.

A system comprising: at least one processor; and a non-transitory computer-readable storage medium having instructions stored which, when executed by the at least one processor, cause the at least one processor to perform operations comprising: receiving a plurality of data, the data comprising at least one of hydrological, soil, and weather data associated with a geographic region; generating, based on the plurality of data, at least one likely rainfall event series for the geographic region; building a storm pattern model using the at least one likely rainfall event series; generating a water scarcity value for the geographic region based on the data and the storm pattern model; receiving an assessment period and a recurrence interval; and executing the storm pattern model using the assessment period, the recurrence interval, and the water scarcity value, resulting in at least one predicted weather effect for the geographic region.

The system of any preceding clause, the non-transitory computer-readable storage medium having additional instructions stored which, when executed by the at least one processor, cause the at least one processor to perform operations comprising: generating, based on the plurality of data, at least one predicted condition of the geographic region, the at least one predicted condition comprising at least one of: a coastal condition, a riverine condition, or a drought condition.

The system of any preceding clause, wherein the at least one predicted weather effect comprises bridge scour.

The system of any preceding clause, wherein the water scarcity value indicates if there is a water excess, a water scarcity, or a water balance in the geographic region.

The system of any preceding clause, wherein the storm pattern model and the least one likely rainfall event series are distinct Artificial Intelligence models.

The system of any preceding clause, wherein the distinct Artificial Intelligence models are trained neural networks.

The system of any preceding clause, the non-transitory computer-readable storage medium having additional instructions stored which, when executed by the at least one processor, cause the at least one processor to perform operations comprising: receiving a hydrological model of the geographic region, wherein the building of the storm pattern model is further based at least in part on the hydrological model.

A non-transitory computer-readable storage medium having instructions stored which, when executed by at least one processor, cause the at least one processor to perform operations comprising: receiving a plurality of data, the data comprising at least one of hydrological, soil, and weather data associated with a geographic region; generating, based on the plurality of data, at least one likely rainfall event series for the geographic region; building a storm pattern model using the at least one likely rainfall event series; generating a water scarcity value for the geographic region based on the data and the storm pattern model; receiving an assessment period and a recurrence interval; and executing the storm pattern model using the assessment period, the recurrence interval, and the water scarcity value, resulting in at least one predicted weather effect for the geographic region.

The non-transitory computer-readable storage medium of any preceding clause, having additional instructions stored which, when executed by the at least one processor, cause the at least one processor to perform operations comprising: generating, based on the plurality of data, at least one predicted condition of the geographic region, the at least one predicted condition comprising at least one of: a coastal condition, a riverine condition, or a drought condition.

The non-transitory computer-readable storage medium of any preceding clause, wherein the at least one predicted weather effect comprises bridge scour.

The non-transitory computer-readable storage medium of any preceding clause, wherein the water scarcity value indicates if there is a water excess, a water scarcity, or a water balance in the geographic region.

The non-transitory computer-readable storage medium of any preceding clause, wherein the storm pattern model and the least one likely rainfall event series are distinct Artificial Intelligence models.

The non-transitory computer-readable storage medium of any preceding clause, wherein the distinct Artificial Intelligence models are trained neural networks.

We claim:

1. A method comprising:
receiving, at a computer system, a plurality of data, the data comprising at least one of hydrological, soil, and weather data associated with a geographic region;
generating, via at least one processor of the computer system based on the plurality of data, at least one likely rainfall event series for the geographic region;
building, via the at least one processor using the at least one likely rainfall event series, a storm pattern model;
generating, via the at least one processor, a water scarcity value for the geographic region based on the data and the storm pattern model;
receiving, at the computer system, an assessment period and a recurrence interval; and
executing the storm pattern model via the at least one processor using the assessment period, the recurrence interval, and the water scarcity value, resulting in at least one predicted weather effect for the geographic region.

2. The method of claim 1, further comprising:
generating, via the at least one processor based on the plurality of data, at least one predicted condition of the geographic region, the at least one predicted condition comprising at least one of: a coastal condition, a riverine condition, or a drought condition.

3. The method of claim 1, wherein the at least one predicted weather effect comprises bridge scour.

4. The method of claim 1, wherein the water scarcity value indicates if there is a water excess, a water scarcity, or a water balance in the geographic region.

5. The method of claim 1, wherein the storm pattern model and the least one likely rainfall event series are distinct Artificial Intelligence models.

6. The method of claim 5, wherein the distinct Artificial Intelligence models are trained neural networks.

7. The method of claim 1, further comprising:
receiving, at the computer system, a hydrological model of the geographic region,
wherein the building of the storm pattern model is further based at least in part on the hydrological model.

8. A system comprising:
at least one processor; and
a non-transitory computer-readable storage medium having instructions stored which, when executed by the at least one processor, cause the at least one processor to perform operations comprising:
receiving a plurality of data, the data comprising at least one of hydrological, soil, and weather data associated with a geographic region;
generating, based on the plurality of data, at least one likely rainfall event series for the geographic region;
building a storm pattern model using the at least one likely rainfall event series;
generating a water scarcity value for the geographic region based on the data and the storm pattern model;
receiving an assessment period and a recurrence interval; and
executing the storm pattern model using the assessment period, the recurrence interval, and the water scarcity value, resulting in at least one predicted weather effect for the geographic region.

9. The system of claim 8, the non-transitory computer-readable storage medium having additional instructions stored which, when executed by the at least one processor, cause the at least one processor to perform operations comprising:
generating, based on the plurality of data, at least one predicted condition of the geographic region, the at least one predicted condition comprising at least one of: a coastal condition, a riverine condition, or a drought condition.

10. The system of claim 8, wherein the at least one predicted weather effect comprises bridge scour.

11. The system of claim 8, wherein the water scarcity value indicates if there is a water excess, a water scarcity, or a water balance in the geographic region.

12. The system of claim 8, wherein the storm pattern model and the least one likely rainfall event series are distinct Artificial Intelligence models.

13. The system of claim 12, wherein the distinct Artificial Intelligence models are trained neural networks.

14. The system of claim 8, the non-transitory computer-readable storage medium having additional instructions stored which, when executed by the at least one processor, cause the at least one processor to perform operations comprising:
receiving a hydrological model of the geographic region,
wherein the building of the storm pattern model is further based at least in part on the hydrological model.

15. A non-transitory computer-readable storage medium having instructions stored which, when executed by at least one processor, cause the at least one processor to perform operations comprising:
receiving a plurality of data, the data comprising at least one of hydrological, soil, and weather data associated with a geographic region;
generating, based on the plurality of data, at least one likely rainfall event series for the geographic region;
building a storm pattern model using the at least one likely rainfall event series;
generating a water scarcity value for the geographic region based on the data and the storm pattern model;
receiving an assessment period and a recurrence interval; and
executing the storm pattern model using the assessment period, the recurrence interval, and the water scarcity value, resulting in at least one predicted weather effect for the geographic region.

16. The non-transitory computer-readable storage medium of claim 15, having additional instructions stored which, when executed by the at least one processor, cause the at least one processor to perform operations comprising:
generating, based on the plurality of data, at least one predicted condition of the geographic region, the at least one predicted condition comprising at least one of: a coastal condition, a riverine condition, or a drought condition.

17. The non-transitory computer-readable storage medium of claim 15, wherein the at least one predicted weather effect comprises bridge scour.

18. The non-transitory computer-readable storage medium of claim 15, wherein the water scarcity value indicates if there is a water excess, a water scarcity, or a water balance in the geographic region.

19. The non-transitory computer-readable storage medium of claim 15, wherein the storm pattern model and the least one likely rainfall event series are distinct Artificial Intelligence models.

20. The non-transitory computer-readable storage medium of claim 19, wherein the distinct Artificial Intelligence models are trained neural networks.
